(19) United States
(12) Patent Application Publication
(10) Pub. No.: US 2026/0268084 A1
(43) Pub. Date: Sep. 10, 2026

(54) INTEGRATION ENGINE(S) FOR INTEGRATING LEGACY VIRTUAL ASSISTANTS WITH ARTIFICIAL INTELLIGENCE SYSTEMS

(71) Applicant: Oracle International Corporation, Redwood City, CA (US)

(72) Inventors: Laurentiu Busuioc, Alameda, CA (US); Kishan Kumar Agrawal, Fremont, CA (US)

(21) Appl. No.: 19/073,234

(22) Filed: Mar. 7, 2025

(51) Int. Cl. G06F 40/30; G06N 20/00

(52) U.S. Cl. CPC G06F 40/30; G06N 20/00

(57) ABSTRACT

Various embodiments of the present technology generally relate to systems and methods for providing an integration engine. In an aspect, a method includes receiving, by an integration engine, a user query via a virtual assistant (VA) application. Responsive to receiving the user query, a state machine of the integration engine determines a first transition state for the integration engine based on the user query. In this example, the first transition state initiates the integration engine to interact with an artificial intelligence (AI) system that is external to the VA application. Based on the first transition state, the integration engine generates an input to the AI system using the user query. Responsive to receiving an output from the AI system, the integration engine determines a second transition state. Based on the second transition state, the VA application generates an answer to the user query using the output from the AI system.

### TECHNICAL FIELD

Various embodiments of the present technology generally relate to virtual assistant applications (“VA applications”). More specifically, embodiments of the present technology relate to systems and methods for providing integration engine(s) for integrating legacy natural language processing (NLP) based VA applications with artificial intelligence (AI) systems.

### BACKGROUND

Traditional NLP-based VA applications have been a cornerstone of automated customer interaction, leveraging NLP to understand user intent and respond accordingly. These VA applications operate using predefined rule-based logic, decision trees, or intent classification models that map user queries to specific responses. By integrating with a business's knowledge base or structured databases, VA applications provide functionality such as answering FAQs, guiding users through workflows, and offering navigational shortcuts within applications. Many businesses have deployed these VA applications across websites, customer service portals, and enterprise systems to improve user engagement and reduce human workload.

Despite the emergence of more advanced AI systems, such as Large Language Models (LLMs), NLP-based VA applications remain widely used due to their reliability, ease of integration, and structured control over interactions. Industries such as banking, healthcare, and e-commerce continue to rely on them for transactional queries, appointment scheduling, and troubleshooting, where predictable and consistent responses are essential—particularly in regulated environments that demand accuracy and compliance. Organizations heavily depend on legacy NLP-based VA applications, which are often deeply embedded within existing infrastructures. As a result, integrating advancing AI systems, such as LLMs, into these legacy frameworks requires extensive architectural rework, significant financial investment, and considerable time. These challenges create substantial barriers, preventing seamless adoption of LLMs and limiting enterprises'ability to modernize their VA applications.

Accordingly, there exists a need for integration engine(s) that provide improved approaches and architectures for integrating NLP-based VA applications with AI systems. In particular, the integration engine(s) provided herein provide more modular and decoupled architectures that offer greater flexibility and scalability for integrating LLM-based technologies into legacy NLP-based VA applications.

The information provided in this section is presented as background information and serves only to assist in any understanding of the present disclosure. No determination has been made and no assertion is made as to whether any of the above might be applicable as prior art with regard to the present disclosure.

### OVERVIEW

Technology is disclosed herein for systems and techniques for providing an integration engine and its related functions. In an aspect, an integration engine may be provided as part of a legacy virtual assistant (VA) application to integrate an AI system with the VA application. The AI system may be external to the VA application, such as executed separately from the VA application or by a third party. When the VA application receives a user query from a client device, the integration engine may process the user query to determine a first transition state. In an example, the VA application may initially process the user query to determine an intent of the user query and provide the intent along with the user query to the integration engine. The integration engine may then determine the first transition state based on the intent.

In an example, the first transition state may indicate that the user query is a valid query, such as having a valid intent. As such, the first transition state may direct the integration engine to generate an input to the AI system. The input may include the user query and the intent. Responsive to receiving the input, the AI system may generate a first output containing a response. The response may be generated by an LLM that is hosted as part of the AI system. Responsive to receiving the first output, the integration engine may evaluate the output to determine whether further refinement of the response is required. Based on the output, the integration engine may determine a second transition state for the integration engine or the VA application. If the integration engine determines that the response provided in the output from the AI system is complete, then the second transition state may direct the VA application to generate an answer to the user query. In particular, the VA application may be directed to generate the answer using the response provided in the output from the AI system. Once generated, the answer is transmitted by the VA application to the client device where it may be viewed via a user interface of the client device.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

The accompanying drawings, which are incorporated into and constitute a part of this specification, illustrate one or more certain aspects and, together with the description of the example, serve to explain the principles and implementations of the certain examples.

FIG. 1 illustrates an example operational environment in which an integration engine is leveraged to integrate an AI system with a VA application, according to an embodiment herein;

FIG. 2 illustrates an example architectural arrangement for a VA application interacting with an AI system, according to an embodiment herein;

FIG. 3 illustrates an example operational environment including an integration engine, according to an embodiment herein;

FIG. 4 illustrates an example interface engine process, according to an embodiment herein;

FIG. 5 illustrates an example process for determining a transition state for the integration engine and/or a VA application, according to an embodiment herein;

FIG. 6 illustrates an example operational flow for providing one or more functions of the integration engine, according to an embodiment herein; and

FIG. 7 shows an example computing device suitable for providing an integration engine and its related functions, according to an embodiment herein.

Some components or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

In the modern era, organizations and enterprises increasingly rely on VA applications to streamline user interactions, enhance customer engagement, and improve operational efficiency. These AI-driven systems serve as the first point of contact for users, handling a wide range of tasks such as answering inquiries, processing transactions, scheduling appointments, and providing personalized recommendations. By integrating with business systems, VA applications enable seamless self-service experiences, reducing the need for human intervention while ensuring round-the-clock availability. Industries such as banking, healthcare, retail, and telecommunications leverage VAs to enhance customer support, optimize workflows, and drive business growth. As user expectations for instant and intelligent responses continue to rise, enterprises depend on these applications to deliver consistent, scalable, and cost-effective interactions, making them an essential component of modern digital ecosystems.

Conventional VA applications are heavily structured around NLP technologies, which enable them to interpret and respond to user queries. These systems rely on predefined rules, intent recognition, and entity extraction to understand user inputs and map them to corresponding actions or responses. Typically, NLP-based VA applications follow a structured business logic flow, where user queries are categorized into specific intents, triggering scripted responses or workflows. This rule-based approach allows for precise control over interactions, ensuring consistent and predictable outputs—an essential feature for industries requiring accuracy and compliance. Furthermore, these systems are often tightly integrated with an organization's existing databases and backend services, allowing them to perform tasks like retrieving account information, processing orders, or managing support tickets. While effective for handling routine queries, this rigid structure limits their flexibility and adaptability to more complex or ambiguous user requests, posing challenges as conversational AI technologies continue to advance.

In recent years, advancements in AI technologies, particularly LLMs, have significantly expanded the capabilities and enhanced the user experience within VA applications. Unlike traditional NLP-based systems that rely on predefined rules and structured workflows, LLM-powered VAs leverage deep learning and vast datasets to generate more dynamic, contextually relevant, and human-like responses. These models can understand nuanced language, handle open-ended conversations, and adapt to a wider range of user queries without requiring extensive manual programming. Additionally, LLMs enable VAs to provide more personalized interactions by analyzing user history, preferences, and intent in real time. This shift not only improves engagement and satisfaction but also reduces the need for human intervention in complex inquiries.

Despite the advancements in LLMs, many organizations and enterprises remain hesitant to transition from traditional NLP-based VA applications to LLM-powered systems. One of the primary concerns is the cost and complexity of migration. Many businesses have already heavily invested in developing, fine-tuning, and integrating their existing VA application logic, workflows, and backend systems. Moving to an LLM-based architecture often requires extensive reworking of business logic, retraining employees, and ensuring compatibility with legacy systems, all of which can be both time-consuming and resource-intensive. Furthermore, data privacy and security remain significant barriers, as LLMs rely on vast datasets and external processing, raising concerns about compliance with industry regulations such as General Data Protection Regulation (GDPR) and Health Insurance Portability and Accountability Act (HIPAA), which are critical for sectors like healthcare, finance, and legal services.

Additionally, lack of control and predictability in LLM-generated responses adds another layer of complexity. Unlike traditional rule-based NLP systems, which provide structured, deterministic outputs, LLMs generate responses probabilistically, which can sometimes result in inconsistencies, incorrect information, or non-compliant answers. This unpredictability poses considerable risks in highly regulated industries where accuracy and adherence to legal standards are paramount. Moreover, concerns around technological instability and vendor dependence also arise, as advancements in LLM technology may not guarantee backward compatibility, potentially forcing businesses into continuous upgrades and costly retraining. Given these challenges, many enterprises opt to retain their traditional NLP-based VA applications, prioritizing stability, compliance, and cost efficiency over the uncertain benefits of integrating LLM-driven automation.

Due to these significant obstacles, organizations and enterprises are often left relying on their legacy NLP-based VA applications. While these systems provide stability and meet compliance requirements, their continued use comes with a set of drawbacks that hinder the potential for innovation and efficiency. First, legacy NLP-based systems are inherently limited in their ability to handle more complex, open-ended user queries. These systems rely on predefined rules and rigid workflows, making it difficult to adapt to new conversational scenarios or provide personalized experiences without extensive manual intervention. As a result, user interactions can feel mechanical, resulting in a less engaging and often frustrating customer experience.

Furthermore, relying on outdated NLP technology means organizations miss out on the significant advancements in AI, such as those enabled by LLMs. For instance, LLMs offer the ability to understand and generate more nuanced, contextually relevant responses, allowing for more natural, fluid conversations that feel more human-like. This advancement in conversational AI not only improves user satisfaction but also drives greater operational efficiency by reducing the need for human intervention in handling complex or non-routine inquiries. Without integrating modern AI technologies, businesses risk falling behind competitors who are leveraging these innovations to enhance their virtual assistant capabilities, leaving them at a disadvantage in an increasingly AI-driven marketplace.

To address at least the shortcomings of conventional approaches noted above, an example integration engine is provided herein. In particular, the integration engine provided herein allows for integration of an AI system with a legacy VA application. As will be described in greater detail below, the integration engine allows organizations and enterprises to integrate advancing AI systems, such as LLMs, with legacy VA applications. In an embodiment, to allow for such integration, the integration engine may be in operable communication with a legacy VA application. In some cases, the integration engine may replace or augment the dialogue flow of the legacy VA application, such to perform one or more functions on behalf of the legacy VA application. In an example, after the legacy VA application determines an intent of a received user query, the integration engine may leverage the intent to determine whether the legacy VA application should generate an answer based on its dialogue flow or whether an AI system should generate a response to the user query.

As will be described in greater detail below, to determine how the VA application should handle a received user query, the integration engine may include a state machine, such as a super simple machine. A state machine is a computational model that transitions between predefined states or configurations based on predefined inputs and rules, enabling controlled execution of processes or workflows. As such, depending on the intent of a user query, the state machine determines a subsequent state for the integration engine, which may include generating an input for the AI system or directing the VA application to generate an answer.

By leveraging an integration engine, organizations and enterprises can create a bridge between legacy VA applications and advancing AI systems. Integration of AI systems with legacy VA applications provides a seamless enhancement of capabilities without requiring significant modifications to existing architectures. Legacy VA applications, often embedded within organizational applications, can retain their current workflows while leveraging AI-based enhancements such as improved natural language understanding, contextual awareness, and dynamic response generation. As such, the integration engine allows organizations to utilize their existing infrastructure while leveraging AI advancements. Furthermore, as AI systems continue to evolve, these improvements are automatically realized by the legacy VA applications through the integration engine, enabling VA applications to offer increasingly sophisticated interactions and functionality over time without the need for frequent redevelopment or reconfiguration.

By utilizing AI systems, such as LLMs, within VA applications, organizations can realize numerous advantages, particularly in enhancing user experiences. LLMs enable more natural, contextually aware, and personalized interactions, improving user engagement and satisfaction. These AI systems can process and generate human-like responses, handle complex queries, and adapt to various conversational styles, making interactions more efficient and intuitive. Additionally, AI systems, when leveraged within a VA context, can scale effortlessly, supporting high volumes of inquiries while maintaining consistent quality. Organizations also benefit from continuous learning and adaptation, as AI systems improve over time through exposure to new data and user interactions, ensuring that the VA application remains relevant and effective in meeting evolving customer and employee needs.

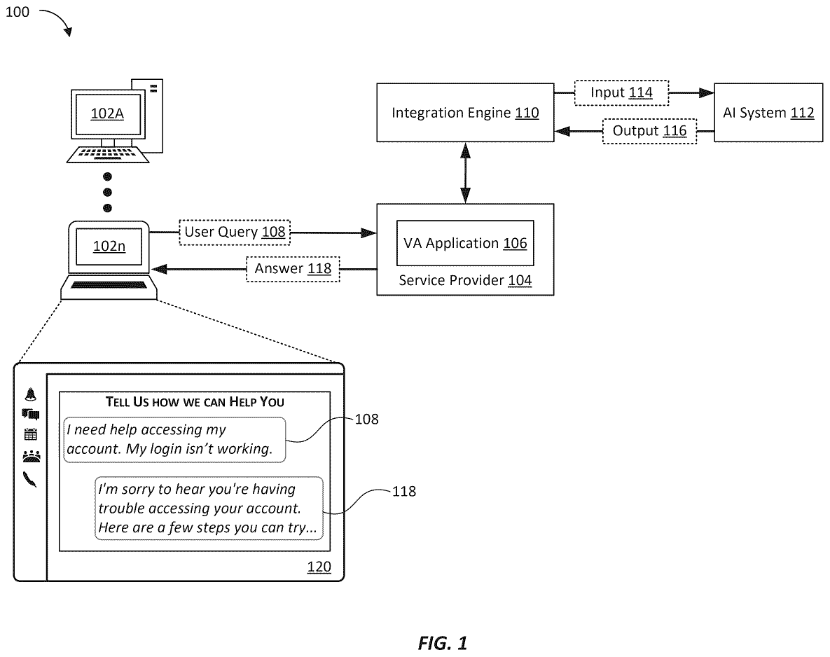

Turning now to FIG. 1, an example operational environment 100 in which an integration engine 110 is leveraged to integrate an AI system 112 with a VA application 106 is provided, according to an embodiment herein. As illustrated, the operational environment 100 includes client devices 102A-n that interact with a service provider 104. The service provider 104 offers a range of products and services that are consumed by users of the client devices 102A-n. To facilitate this interaction, the service provider 104 leverages a virtual assistant (VA) application 106, which enables the client devices 102A-n to communicate with the service provider 104.

The VA application 106 may be a chatbot application that utilizes one or more natural language processing (NLP) techniques to facilitate communication between the client devices 102A-n and the service provider 104. By leveraging NLP, the VA application 106 can interpret, understand, and respond to user queries in a conversational manner, enabling users to interact with the service provider 104 in a natural and intuitive way. These NLP techniques may include text parsing and sentiment analysis, allowing the VA application 106 to provide contextually relevant responses and perform tasks such as answering queries, processing requests, and offering personalized recommendations based on the user's query.

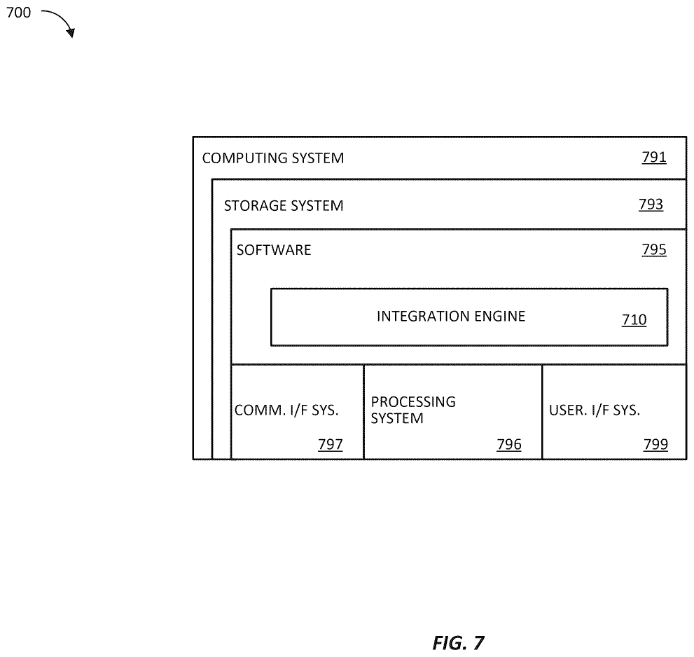

Broadly speaking, the client devices 102A-n can include a wide range of devices such as personal computers, tablet computers, mobile phones, gaming consoles, wearable devices, Internet of Things (IoT) devices, and any other suitable devices. The client devices 102A-n, represented by system 700 in FIG. 7, communicate with the service provider 104 through various networks. These networks can include the Internet, intranets, wired and wireless networks, local area networks (LANs), wide area networks (WANs), or any combination thereof.

As illustrated, a user of client device 102n submits a user query 108 to the service provider 104 via the VA application 106. The VA application 106 may be a legacy system integrated into various applications, networks, and workflows throughout the service provider 104. Unlike modern AI-powered assistants, the VA application 106 may be a non-intelligent application, meaning it primarily relies on NLP techniques and predefined rules to respond to the user query 108. As such, the VA application 106 may process the user query 108 by matching keywords and phrases to a set of predefined responses or actions, rather than employing advanced machine learning or contextual understanding.

Due to its reliance on predefined rules and basic NLP processing, the VA application 106 may encounter several limitations in effectively addressing user queries 108. Without the use of advanced AI technologies, such as machine learning or LLMs, the VA application 106 is constrained to responding to specific keywords or phrases, often leading to inaccurate or overly simplistic responses. Additionally, the VA application 106 may struggle to handle complex or ambiguous user queries 108, as it lacks the ability to understand context or intent beyond the predefined rules. In some scenarios, the VA application 106 may fail to adapt to evolving language patterns or user preferences, resulting in a rigid and less personalized user experience. As a result, users may experience frustration when the VA application 106 is unable to provide relevant or precise answers, reducing the overall effectiveness and satisfaction with the service provider 104.

The service provider 104 may be unable or reluctant to replace the VA application 106 with a more advanced system due to its legacy nature. That is, the VA application 106 may be deeply integrated into various critical applications, networks, and workflows within the service provider's 104 infrastructure, making a complete overhaul or rework of the VA application 106 a complex and costly task. The service provider 104 may face budgetary constraints, resource limitations, or operational challenges that hinder the transition to a more advanced AI-based application. As a result, despite the limitations of the VA application 106, the service provider 104 may, under conventional solutions, opt to continue using legacy application rather than switching to a more sophisticated, AI-powered alternative.

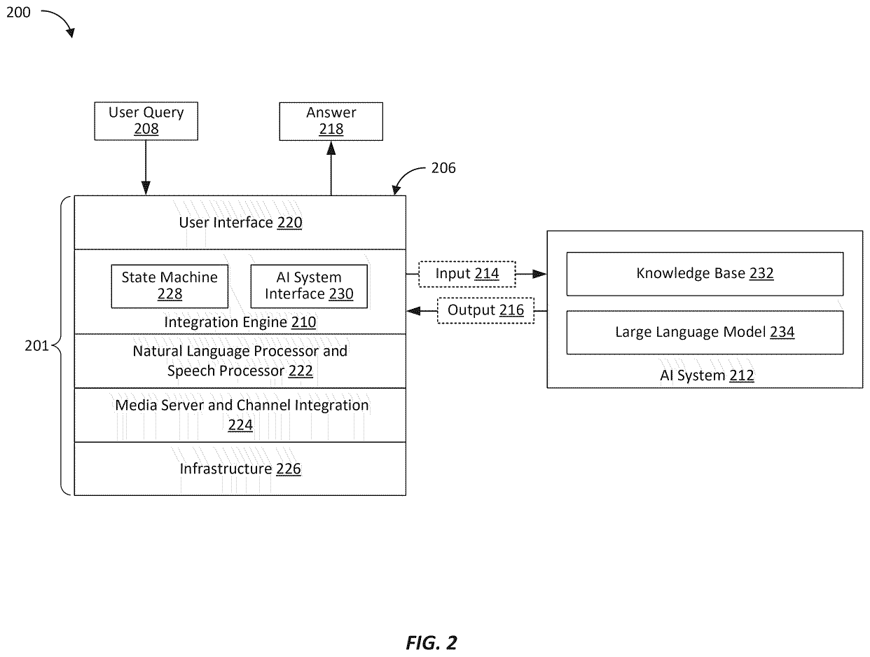

In the illustrated example, however, the service provider 104 leverages the integration engine 110 to interface with the AI system 112, thereby realizing the technological advancements provided the AI system 112 without requiring an overhaul or replacement of the legacy VA application 106. As will be described in greater detail with respect to FIG. 2, in some embodiments, the integration engine 110 may be integrated into the overall architecture of the VA application 106 to provide a bridge between the VA application 106 and the AI system 112. Although the AI system 112 is illustrated as separate from or external to the service provider 104, in some embodiments, the AI system 112 may be part of the service provider 104, but separate from the VA application 106.

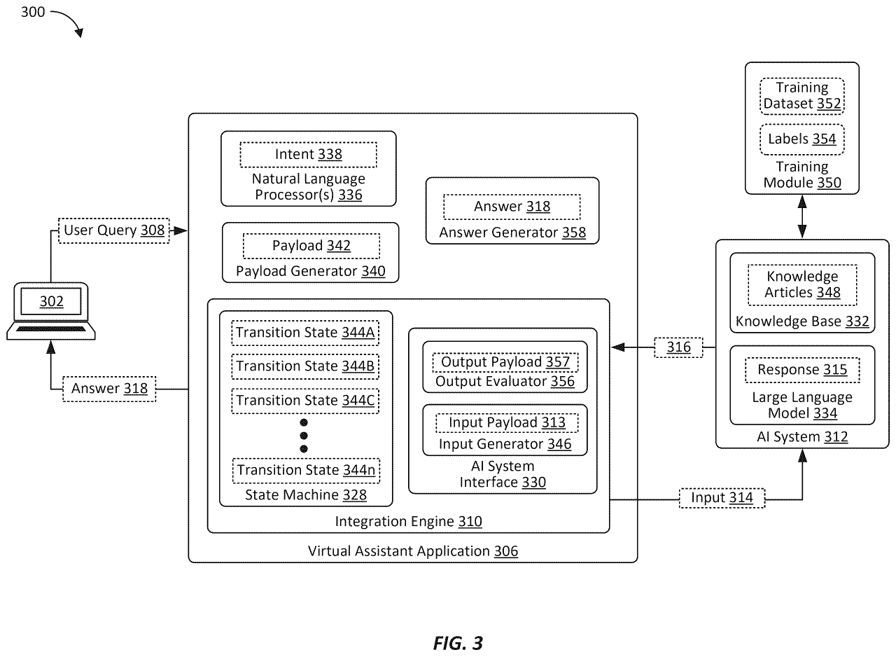

Following the illustrated example, responsive to receiving the user query 108, the VA application 106 processes the user query 108 to determine an intent of the user query 108. The user query 108 and the intent are passed to the integration engine 110. The integration engine 110 processes the intent of the user query 108 to determine a next transition state. As described in greater detail below with respect to FIGS. 3-6, the integration engine 110 may include a state machine that determines the state or configuration of the integration engine based on the intent of the user query 108. In the illustrated example, the transition state determined by the state machine directs the integration engine 110 to interact with the AI system 112 to generate a response to the user query 108.

To interact with the AI system 112, the integration engine 110 generates an input 114. The input 114 may include the user query 108 and, in some cases, the intent of the user query 108. Responsive to generation, the input 114 is submitted to the AI system 112 for processing. The AI system 112 may be or include one or more AI or machine learning (ML) models, such as an LLM, a retrieval-augmented generation (RAG) model, or other advanced models designed to understand, analyze, and generate contextually relevant responses. As such, the AI system 112 is able to leverage vast amounts of data and sophisticated algorithms to enhance the accuracy and relevance of a response, enabling more natural and intelligent interactions compared to traditional, rule-based systems, such as the VA application 106.

Responsive to receiving the input 114, the AI system 112 may generate an output 116 containing a response to the user query 108. As will be described in greater detail below, the AI system 112 may be trained to identify contextually relevant knowledge articles based on the intent, and in some cases, metadata associated with the user query 108. Using the identified contextually relevant knowledge articles, the AI system 112 generates an output 116 containing a response to the user query 108. The output 116 is provided to the integration engine 110, which may validate the response. In some embodiments, validating the output 116 may include determining whether the response is contextually accurate in view of the user query 108 and/or determine whether any additional refinement is required to the response (e.g., summarization, rewording).

Using the output 116, the integration engine 110 determines a next transition state. Depending on the output 116, the integration engine 110 may determine that the next transition state includes providing the output 116 generated by the AI system 112 to the VA application 106. Responsive to receiving the output 116, the VA application 106 generates an answer 118 to the user query 108. The answer 118 may include the response or content from the response provided in the output 116. As shown, the client device 102n may interact with the VA application 106 through a user interface 120 displayed on the client device 102n. The user interface 120 serves as the primary medium for interacting with the VA application 106, allowing the user to submit queries 108 and receive answers 118. Accordingly, the answer 118 generated by the VA application 106 may be presented to the user via the user interface 120, enabling the user to view and interact with the answer 118 in real time.

Turning now to FIG. 2, an example architectural arrangement for a VA application 206 interacting with an AI system 212 is illustrated, according to an embodiment herein. As shown, the VA application 206, which may be the same or similar to the VA application 106, may include an architectural stack 201 including a user interface 220, which may be the same or similar to the user interface 120. The user interface 220 may correspond to a presentation layer of the architectural stack 201 and includes various UI elements that users interact with, whether it's a chatbot interface, voice assistant, or mobile/web application. As such, when a user submits a user query 208 to the VA application 206, the user query 208 is received by the VA application 206 through the user interface 220.

The next layer on the architectural stack 201 of the VA application 206 includes the integration engine 210, which may be the same or similar to the integration engine 110. The integration engine 210 may be part of a logic layer within the architectural stack 201. As will be expanded on below, the integration engine may determine a transition state for the VA application and determine the next action based on a previous payload, such as a payload generated for the user query 208.

The architectural stack 201 includes a natural language processor and/or speech processor (NLP/SP) 222, which may be part of the intelligence layer of the VA application 206. The NLP/SP 222 comprises various processing components, including Automatic Speech Recognition (ASR) for converting voice input into text, Natural Language Processing (NLP) for tasks such as tokenization and entity recognition to interpret user query 208, and Natural Language Generation (NLG) for generating coherent responses, such as answer 218. These components collectively enable the VA application 206 to process and respond to both spoken and written queries effectively.

The architectural stack 201 of the VA application 206 also includes a media server and channel integration module 224, which facilitates interactions across multiple platforms, such as web, mobile, voice (SIP, WebRTC), and messaging applications (e.g., WhatsApp, Slack). Additionally, it provides API-based support for omnichannel communication. The media server and channel integration module 224 may be part of the communication layer of the VA application 206, ensuring seamless connectivity and message delivery across different interaction channels. Finally, the architectural stack 201 may also include infrastructure 226, which forms the foundation layer of the VA application 206. The infrastructure 226 may encompass cloud services, databases, and compute resources (e.g., AWS, Azure, Kubernetes, serverless functions) that provide the necessary scalability, storage, and processing power to support the VA application 206's operations.

The architectural stack 201 of the VA application 206 is designed to enable seamless processing of user queries by integrating various layers that handle interaction, interpretation, communication, and infrastructure support. Conventionally, when a user submits a query 208 through the user interface 220, the query 208 is first received and processed by a dialog flow component. However, in the illustrated architectural stack 201, when a user query 208 is received, the query 208 is processed by the integration engine 210. As will be described in greater detail below with respect to FIGS. 3-6, the integration engine 210 manages the conversation structure and determines the next steps for the VA application. For example, the integration engine 210 may forward the user query 208 to the intelligence layer, where the NLP/SP 222 analyzes the user query 208 to determine an intent. If the user query 208 is voice-based, the ASR component within the NLP/SP 222 converts it into text using NLP techniques, such as tokenization and entity recognition, extract relevant information, including determining an intent.

Once the intent of the user query 208 is determined, the integration engine 210 may process the user query 208 and the intent. In particular, the integration engine 210 may include a state machine 228 that processes the user query 208 and intent to determine the next steps or state of the VA application. If the state machine 228 determines that the intent is a valid intent, as described below, the integration engine 210 generates an input payload for an AI system 212, which may be the same or similar to the AI system 112. The input payload includes at least the user query 208 and may be submitted as an input 214 by an AI system interface 230 of the integration engine 210 to the AI system 212.

The AI system 212 may include acknowledge base 232 and an LLM 234. As such, responsive to receiving the input 214, the AI system 212 may process the user query 208 that is provided as part of the input 214 to generate a response. In some cases, the AI system 212 may query a knowledge base 232 for knowledge articles (e.g., documents, Q&A articles, technical manuals) to identify contextually relevant information for generating a response to the user query 208. Using the identified knowledge articles, the LLM 234 may generate a response to the user query 208 and provide it to the integration engine 210 as an output 216.

Responsive to receiving the output 216, the state machine 228 of the integration engine 210 may process the output 216, in particular the response provided in the output 216, to determine a next state for the VA application 206. If the response is a valid response, and no additional refinement of the response is required, as described below, the integration engine 210 may transmit the response through the communication layer, where the media server and channel integration module 224 ensures proper routing and formatting of the response for the intended platform, whether it be web, mobile, voice, or a messaging application. The response is then provided to the user as an answer 218 to the user query 208 via the user interface 220.

By replacing a conventional dialog flow component within the architectural stack 201 of the VA application 206, the integration engine 210 manages the conversation flow between the user and the VA application 206. Specifically, the integration engine 210 determines a subsequent state of the VA application 206 based on the user query 208, and in some cases, the output 216, including when to direct a user query to the AI system 212 that is external to the VA application 206. In this manner, the integration engine 210 allows the VA application 206 to leverage advancing AI-based technologies without impacting the architecture of the underlying legacy system.

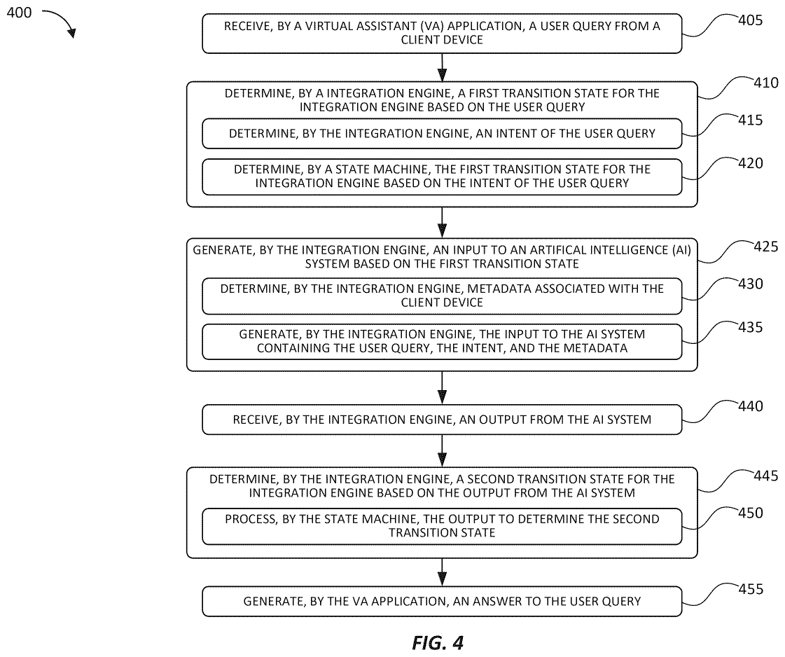

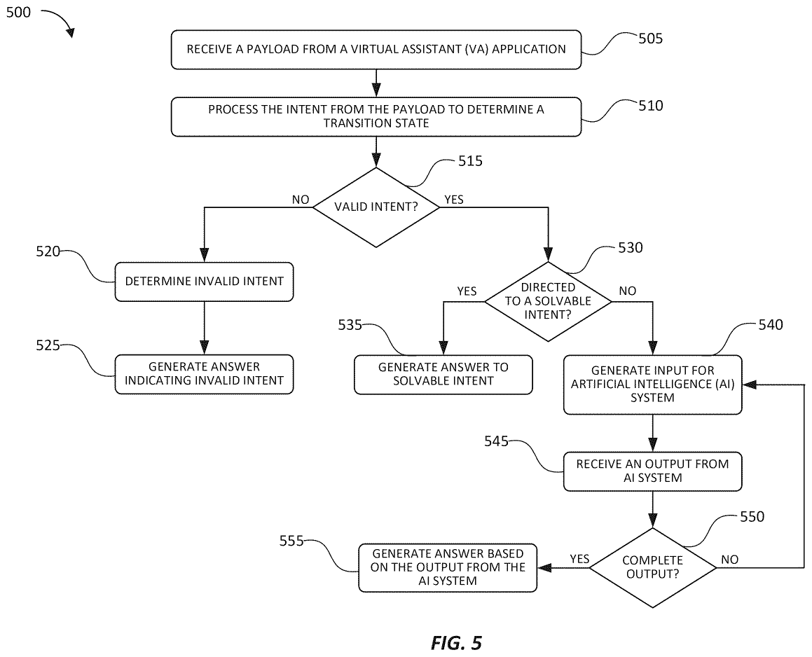

Referring now to FIG. 3, an example operational environment 300 including an integration engine 310 is illustrated, according to an embodiment herein. For ease of explanation, FIG. 3 is discussed in conjunction with FIGS. 4-5. Starting with FIG. 4, an example integration engine process, in particular a process 400 for providing the integration engine 310 and one or more of its functions, is provided, according to an embodiment herein. While FIG. 4 is described with relation to FIG. 3, it should be appreciated that components, elements, and steps from any other Figures described herein may be equally applicable.

As shown, the operational environment 300 may be the same or similar to the operational environment 100 in that a user of a client device 302 interacts with a VA application 306 to address a concern or question. The VA application 306, which may be the same or similar to the VA application 106, may receive a user query 308 from the client device, which may be the same or similar to any of the client devices 102A-n (405). Responsive to receiving the user query 308, the integration engine 310 may determine a first transition state for the VA application 306 and/or the integration engine 310 based on the user query 308 (410). To determine the first transition state, the integration engine 310 may determine an intent 338 of the user query 308 (415). In some embodiments, the VA application 306 determines the intent 338 of the user query 308. As described above, responsive to receiving the user query 308, the VA application 306 processes the user query 308 via one or more natural language (NL) processors 336. As part of this processing, the VA application 306 determines the intent 338 of the user query 308.

In some embodiments, the VA application 306 includes a payload generator 340 that generates a payload 342 based on processing the user query 308. Specifically, the payload generator 340 receives the intent 338 identified by the NL processor(s) 336, which includes the extracted intent 338 of the user query 308. In some embodiments, the NL processor(s) 336 also determine metadata associated with the user query 308. This metadata may include business objects or user objects relevant to the user query 308. Example business objects may include transactional records, product catalogs, service requests, invoices, or customer relationship management (CRM) data. Example user objects may include user profiles, preferences, historical interactions, authentication credentials, or access permissions. As will be described below, enriching the payload 342 with this metadata facilitates a tailored and accurate response generation.

Once the payload 342 is generated, the integration engine 310 determines the first transition state using the payload 342. Specifically, the integration engine 310 includes a state machine 328, which processes the intent 338 of the user query 308 to determine the first transition state for the integration engine 310 (420). The state machine 328 may be a computational model that consists of a finite set of states, transitions between those states, and actions triggered by those transitions. In some embodiments, the state machine 328 may be a simple finite state machine (FSM) that determines a transition state for the integration engine 310—or, in some embodiments, for the VA application 306—by selecting from different transition states 344A-n based on the intent 338. In some implementations, the state machine 328 may be a deterministic finite state machine (DFSM), where each state transition is uniquely determined by the current state and input, or a non-deterministic finite state machine (NDFSM), where multiple transitions may be possible for a given state and input. Alternatively, the state machine 328 may be a hierarchical state machine (HSM) or a probabilistic state machine, such as a Markov decision process (MDP), to support more complex decision-making processes.

In some embodiments, the payload 342 is submitted as an input into the state machine 328 and the first transition state, herein after the first transition state 344A, is determined using the payload 342. In particular, the state machine 328 determines the first transition state 344A based on the intent 338 that is included in the payload 342. Referring now to FIG. 5, an example process 500 for determining a transition state based on the intent 338 is illustrated, according to an embodiment herein. In an example, the process 500 may be performed by the state machine 328 for determining a next transition state of the transition states 344A-n for the integration engine 310 and/or VA application 306.

As illustrated, the state machine 328 may receive the payload 342 from the VA application 306 (505). Responsive to receiving the payload 342, the state machine 328 processes the intent 338 from the payload 342 to determine the first transition state 344A (510). From the processing, the state machine 328 determines whether the intent 338 is a valid intent (515). A valid intent is an intent of the user query 308 that falls within the predefined scope, regulatory compliance, and ethical guidelines governing the VA application's 306 ability to respond. A user query 308 having a valid intent is also referred to herein as a valid query. If the user query 308 contains prohibited content, such as a request for personally identifiable information, illegal activities, or content that violates ethical standards, the intent 338 is classified as an invalid intent. Additionally, an intent 338 may be deemed invalid if the VA application 306 is unable to interpret the request, such as when the user query 308 consists of nonsensical or unintelligible input (e.g., gibberish or random characters). In such cases, the VA application 306 may determine the intent 338 as an invalid intent. A user query 308 having an invalid intent is also referred to herein as an invalid query.

If during processing of the intent 338, the state machine 328 determines an invalid intent (520), the state machine 328 determines the first transition state 334A as an “error” state. An “error” state may direct the VA application 306 to generate an answer indicating the invalid intent (525). For example, the VA application 306 may generate the answer 318 stating “I'm sorry, I can't answer that question.”

However, if during processing of the intent 338, the state machine 328 determines a valid intent, the state machine 328 may then determine whether the intent 338 is directed to a subset of valid intents (530). The subset of valid intents may be intents that are solvable by the VA application 306, herein after referred to as “solvable intents.” Solvable intents may be user queries 308 that can be addressed with minimal information and do not require complex processing. Examples of solvable intents include intents related to Agent Transfers, After Hours inquiries, or Ticketing. That is, user queries 308 having intents 338 that request to be transferred to an agent, seek after-hours information, or inquire about ticketing details can be handled directly by the VA application 306 without the need for interaction with the AI system 312. If the state machine 328 determines that the intent 338 is directed to a solvable intent, then the first transition state 334A directs the VA application 306 to generate an answer 318 to the user query 308 (535).

In contrast, if the intent 338 is not directed to the solvable intent, the state machine 328 may determine the first transition state 334A to direct the integration engine 310 to interact with the AI system 312. In particular, the first transition state 344A may direct the integration engine 310 to generate an input for the AI system 312 (540). The discussion will now turn to FIGS. 3-4 to describe the embodiment where the first transition state 344A directs the integration engine 310 to interact with the AI system 312, before returning to finish the process 500.

With reference to FIG. 3, responsive to the state machine 328 determining that the first transition state 344A involves interacting with the AI system 312, the integration engine 310 generates an input payload 313 to the AI system 312 (425). In particular, the integration engine 310 may include an AI system interface 330 that interfaces with the AI system 312. The AI system interface 330 may include an input generator 346 that generates the input payload 313. The input generator 346 may generate the input payload 313 to include the user query 308 and the intent 338. In some embodiments, the input generator 346 determines the metadata associated with the client device 302 (430), such as the business objects or user objects identified by the VA application 306 and generates the input payload 313 to include the metadata as well as the user query 308 and intent 338 (435). An illustrative input payload 313, as provided as a JSON payload, is as follows:

```
{“INTENT”:“”, //Account Access Help
“prompt”: “”,//I need help accessing my account. My login isn't working.
“answer”:“”, //text emitted by the system
“pointer”: “”, //next transition state
“metadata”: // runtime configurations for active user
  { “user_profile_object”:“”,
    “business_object”:“” }}
```

Responsive to generating the input payload 313, the AI system interface 330 submits the input payload 313 as an input 314 into the AI system 312. Responsive to receiving the input 314, the AI system 312 processes the input payload 313 to generate a response 315 to the user query 308. To generate the response 315, the AI system 312 may include a knowledge base 332 and a LLM 334. While the illustrated example depicts the AI system 312 as including the knowledge base 332 and the LLM 334, the AI system 312 may include other types of AI-based technologies, such as machine learning models, neural networks, expert systems, or advanced NLP algorithms.

Upon receiving the input payload 313 via the input 314, the AI system 312 processes the input payload 313 to identify one or more relevant knowledge articles 348 within the knowledge base 332 that correspond to the intent 338 and context of the user query 308. For instance, the AI system 312 may perform a semantic search based on the user query 308 to identify relevant knowledge articles 348. Following the above example, if the user query 308 pertains to account access assistance, the AI system 312 may retrieve knowledge articles 348 related to account access procedures. In some instances, the AI system 312 may utilize metadata contained in the input payload 313 to determine the specific account associated with the client device 302, enabling a more refined selection of relevant knowledge articles 348 from the knowledge base 332.

After identifying the relevant knowledge articles 348, the large language model (LLM) 334 generates a response 315 based on the retrieved content. In certain implementations, the AI system 312 employs a Retrieval-Augmented Generation (RAG) approach to enhance response accuracy and contextual relevance. Additionally, in some embodiments, the LLM 334 is trained to retrieve knowledge articles 348 by analyzing the intent 338 embedded in the input 314. For instance, if the detected intent 338 is “Account Access,” the AI system 312 can be trained to locate and prioritize knowledge articles 348 within the knowledge base 332 that address user account access-related issues.

The AI system 312 undergoes training through integration with a training module 350. As depicted, the training module 350 comprises a training dataset 352, which includes various knowledge articles 348, along with corresponding labels 354 that denote the correct intent classifications for each knowledge article 348. By leveraging the training dataset 352 and labels 354, the AI system 312 is trained to accurately identify knowledge articles 348 and generate the response 315 that effectively addresses both the intent 338 and the issue presented in the user query 308. Once the response 315 is generated, the AI system 312 provides the response 315 as an output 316 to the integration engine 310. Responsive to receiving the output 316 from the AI system 312 (440), the integration engine 310 determines a second transition state for the integration engine 310 and/or the VA application 206 (445).

In some embodiments, to determine the second transition state based on the output 316, the integration engine 310 may evaluate the response 315 to determine whether it is a valid response or if further refinement is required. In particular, the AI system interface 330 may include an output evaluator 356 that validates that the response 315 provided in the output 316 is accurate in view of the user query 308. The output evaluator 356 may assess the relevance and correctness of the response 315 by comparing it against the intent 338 and contextual details of the user query 308. In some implementations, the output evaluator 356 may utilize rule-based checks, confidence scoring, or external verification mechanisms to ensure that the generated response 315 aligns with the expected information and does not introduce hallucinations or inaccuracies.

In other embodiments, the output evaluator 356 may determine whether any refinement is required for the response 315. For example, if the response 315 identifies the knowledge articles 348 retrieved by the AI system 312 based on the input 314, the output evaluator 356 may determine that the response 315 should be further refined to summarize the information provided in the knowledge articles 348 in view of the user query 308. Other example refinements that may be identified by the output evaluator 356 may include restructuring the response 315 for clarity, ensuring that key details relevant to the user query 308 are emphasized, or filtering out extraneous information that does not directly address the user's intent 338. Additionally, the output evaluator 356 may suggest modifications to improve coherence, rephrase technical jargon for better user comprehension, or cross-check the response 315 against predefined accuracy thresholds to mitigate potential misinformation. In some cases, the output evaluator 356 may also flag ambiguous or incomplete responses, prompting the AI system 312 to retrieve additional knowledge articles 348 or request further user input for clarification.

Based on evaluation of the response 315, the output evaluator 356 may generate an output payload 357. The output payload 357 may include an output intent indicating whether the response 315 requires further refinement or validation, or if the response 315 is a complete, valid response to the user query 308. The output payload 357 may also include the response 315 provided by the AI system 312. Example intents may include “Summarize,” “Clarify Response,” or “Done.”

Once generated, the output payload 357 is provided to the state machine 328 to determine the second transition state, such as the transition state 344B, for the integration engine 310 and/or VA application 306 (450). Returning now to the process 500 of FIG. 5, this determination is illustrated by steps 545-555. For example, the integration engine 310 receives the output 316 from the AI system 312 (545) and generates the output payload 357. The output payload 357 is then submitted to the state machine 328. The state machine 328 processes the output payload 357 to determine whether the output 316 is a complete output (550). In particular, the state machine 328 determines whether the output intent provided in the output payload 357 indicates that the response is complete, such as “Output Intent: DONE.”

If the state machine 328 determines that the output intent indicates that the output 316 is incomplete, such as the response 315 requires additional refinement, the state machine 328 may determine the second transition state 344B that directs the integration engine 310 to generate a subsequent input 314 for the AI system 312 (540). In contrast, if the state machine 328 determines that the output 316 is complete, then the state machine 328 may determine the second transition state 344B that directs the VA application 306 to generate the answer 318 to the user query 308 based on the output 316 (555).

Returning now to FIG. 3, if the second transition state 344B directs the integration engine 310 to generate a subsequent input 314 to the AI system 312, the input generator 346 may generate a subsequent input payload 313. The subsequent input payload 313 may include the output intent as identified by the output evaluator 356 and the response 315 previously generated by the AI system 312. Following the above example, if the response 315 included the identified knowledge articles 348 and the output evaluator 356 generates the output intent to be “SUMMARIZE”, then the subsequent input payload 313 may include the identified knowledge articles 348, the user query 308, and the output intent of “SUMMARIZE.” In other words, the integration engine 310 generates the subsequent input payload 313 to request that the AI system 312 summarize the knowledge articles 348 identified in the previous output 316.

Responsive to receiving the subsequent input 314, the AI system 312 generates a subsequent response 315. Following the above example, the LLM 334 generates the subsequent response 315 summarizing the knowledge articles 348 identified in the previous output 316. Once generated, the AI system 312 provides the subsequent response 315 as the output 316 to the integration engine 310. The integration engine 310 may follow the same or similar evaluation process for the subsequent response 315 as described above, such as validating that the subsequent response 315 is complete.

As noted above, upon determining that the subsequent response 315 is complete and valid, the output evaluator 356 may generate the output payload 357 to have an output intent of “DONE” or “COMPLETE.” As such, when the state machine 328 receives and processes the output payload 357, the state machine 328 may determine a third transition state, such as the transition state 344C. The third transition state 344C may direct the VA application 306 to generate the answer 318 to the user query 308 using the subsequent response 315. Once generated, the VA application 306 transmits the answer 318 to the client device 302, where the answer 318 may be displayed to a user of the client device 302 via a user interface, such as the user interface 120.

It should be appreciated that while the above description provides an illustrative sequence of events, in particular a sequence of transition states, the sequence of events and transition states for the integration engine 310 and/or VA application 306 varies depending on the user query 308 and intent 338, as well as the output intent of the output payload 357. Overall, the above description is meant to be a non-limiting illustration of how the state machine 328 determines a transition state 344A-n for the integration engine 310 and/or the VA application 306 based on dialog flow of the user interaction, which is initiated by the user query 308.

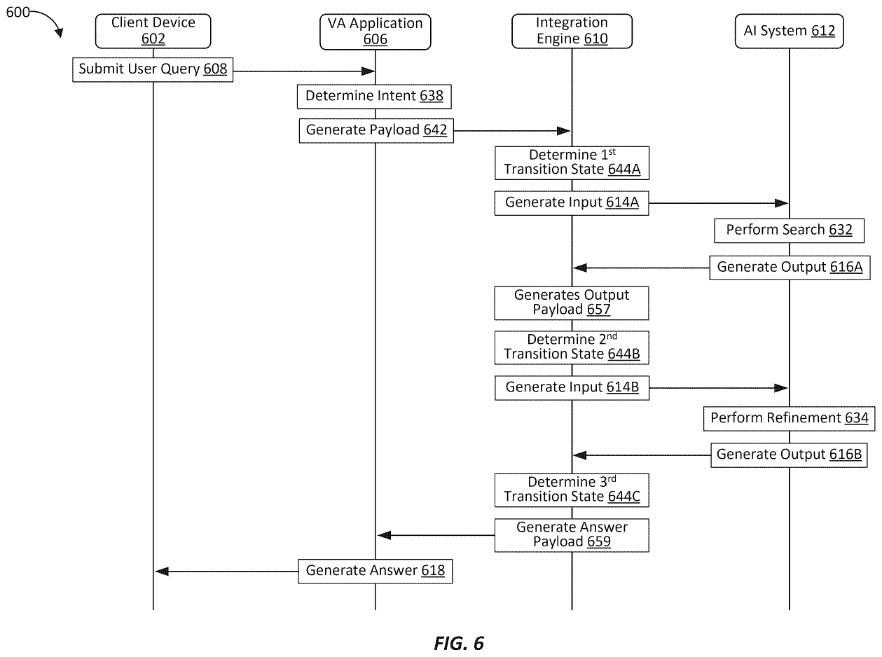

Referring now to FIG. 6, an example operational flow 600 for providing one or more functions of an integration engine 310 is illustrated, according to an embodiment herein. As illustrated, a client device 602, which may be the same or similar to the client device 302, submits a user query 608, which may be the same or similar to the user query 308. In particular, the client device 602 submits the user query 608 to a VA application 606, which may be the same or similar to the VA application 306. Responsive to receiving the user query 608, the VA application 606 processes the user query 608, such as via one or more NL processing techniques, to determine an intent 638 of the user query 308. Using the intent 638, the VA application 606 generates a payload 642 that may include the intent 638, the user query 608, and in some embodiments, metadata associated with the user query 608.

Once generated, the VA application 606 provides the payload 642 to the integration engine 610. As described above, the VA application 606 leverages the integration engine 610, which may be the same or similar to the integration engine 310, to integrate AI-based technologies into its legacy architecture. As such, responsive to receiving the payload 642, the integration engine 310 determines a first transition state 644A. In particular, the integration engine 310 may include a state machine, such as the state machine 328, that determines the first transition state 644A based on the intent 638 provided in the payload 642. In the illustrated example, the state machine determines the first transition state 644A for the integration engine 610 is to generate an input 614A for the AI system 612. As such, the integration engine 610 is directed to generate the input 614A to the AI system 612, which includes the intent 638 and the user query 608.

Responsive to receiving the input 614A, the AI system 612, which may be the same or similar to the AI system 312, may perform a search 632 within a knowledge base, such as the knowledge base 332, to identify knowledge articles that are contextually relevant to the user query 608. In some cases, the AI system 612 may perform a semantic search to identify the relevant knowledge articles. Using the identified knowledge articles, the AI system 612 generates a response and provides the response as an output 616A to the integration engine 610.

When the integration engine 610 receives the output 616A from the AI system 612, the integration engine 610 processes the output 616A to generate an output payload 657. As described above, the output payload 657 includes an output intent that identifies if the response provided in the output 616A is complete or if further refinement is required. The output payload 657 is then processed to determine a second transition state 644B for the integration engine 610. Here, the output intent indicated that further refinement of the response is required. As such, the integration engine 610 is directed to generate a subsequent input 614B for the AI system 612.

The subsequent input 614B is provided to the AI system 612 for refinement. Responsive to receiving the subsequent input 614B, the AI system 612 performs the refinement 634, such as by generating a subsequent response. The subsequent response is then provided to the integration engine 610 as an output 616B. Although not in the illustrated example, the integration engine 610 evaluates the output 616B to determine whether the subsequent response is complete or if additional refinement is required. As part of this evaluation process, the integration engine 610 generates the output payload which is then processed by the state machine to determine a third transition state 644C for the VA application 606. In the illustrated example, the third transition state 644C indicates that the response is complete and as such, directs the VA application 606 to generate an answer 618 to the user query 608.

To direct the VA application 606 to generate the answer 618, the integration engine 610 may generate an answer payload 659. The answer payload 659 may be the same or similar to the output payload 657, such as including the response generated by the AI system 612. Responsive to providing the answer payload 659 to the VA application 606, the VA application 606 generates the answer 618 and provides it to the client device 602.

Referring now to FIG. 7, is a diagram of a system 700 configured to implement an integration engine, according to an embodiment herein. The system 700 may be an example of an apparatus including a computing apparatus 791 that is representative of any system or collection of systems in which the various processes, systems, programs, services, and scenarios disclosed herein may be implemented. For example, computing apparatus 791 may be an example integration engine, such as the integration engine 310, a client device, such as the client device 302, or any of the subcomponents depicted in the operational environments 100, 200, or 300 of FIGS. 1-3, respectively, or viewable flow 600 of FIG. 6. Examples of computing apparatus 791 include, but are not limited to, server computers, desktop computers, laptop computers, routers, switches, web servers, cloud computing platforms, and data center equipment, as well as any other type of physical or virtual server machine, physical or virtual router, container, and any variation or combination thereof.

Computing apparatus 791 may be implemented as a single apparatus, system, or device or may be implemented in a distributed manner as multiple apparatuses, systems, or devices. Computing apparatus 791 may include, but is not limited to, processing system 796, storage system 793, software 795, communication interface system 797, and user interface system 799. Processing system 796 may be operatively coupled with storage system 793, communication interface system 797, and user interface system 799.

Processing system 796 may load and execute software 795 from storage system 793. Software 795 may include an integration engine 1020, which may be representative of any of the operations for providing an integration engine or any of its related functions, as discussed with respect to the preceding figures. When executed by processing system 796, software 795 may direct processing system 796 to operate as described herein for at least the various processes, such as the processes 400 and 500, or flow 600, operational scenarios, and sequences discussed in the foregoing implementations. Computing apparatus 791 may optionally include additional devices, features, or functionality not discussed for purposes of brevity.

In some embodiments, processing system 796 may comprise a micro-processor and other circuitry that retrieves and executes software 795 from storage system 793. Processing system 796 may be implemented within a single processing device but may also be distributed across multiple processing devices or sub-systems that cooperate in executing program instructions. Examples of processing system 796 may include general purpose central processing units, graphical processing units, application specific processors, and logic devices, as well as any other type of processing device, combinations, or variations thereof.

Storage system 793 may comprise any memory device or computer-readable storage medium readable by processing system 796 and capable of storing software 795. Storage system 793 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer-readable storage medium a propagated signal.

In addition to computer-readable storage medium, in some implementations storage system 793 may also include computer readable communication media over which at least some of software 795 may be communicated internally or externally. Storage system 793 may be implemented as a single storage device but may also be implemented across multiple storage devices or sub-systems co-located or distributed relative to each other. Storage system 793 may comprise additional elements, such as a controller, capable of communicating with processing system 796 or possibly other systems.

Software 795 (including the integration engine 710 among other functions) may be implemented in program instructions that may, when executed by processing system 796, direct processing system 796 to operate as described with respect to the various operational scenarios, flows, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 795 may include additional processes, programs, or components, such as operating system software, virtualization software, or other application software. Software 795 may also comprise firmware or some other form of machine-readable processing instructions executable by processing system 796.

In general, software 795 may, when loaded into processing system 796 and executed, transform a suitable apparatus, system, or device (of which computing apparatus 791 is representative) overall from a general-purpose computing system into a special-purpose computing system as described herein. Indeed, encoding software 795 on storage system 793 may transform the physical structure of storage system 793. The specific transformation of the physical structure may depend on various factors in different implementations of this description. Examples of such factors may include, but are not limited to, the technology used to implement the storage media of storage system 793 and whether the computer-storage media are characterized as primary or secondary storage, as well as other factors.

For example, if the computer-readable storage medium are implemented as semiconductor-based memory, software 795 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 797 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between the computing apparatus 791 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more memory devices or computer readable medium(s) having computer readable program code embodied thereon.

The foregoing examples and descriptions are described herein in the context of systems and methods for providing an integration engine or one or more of its related functions. Those of ordinary skill in the art will realize that these descriptions are illustrative only and are not intended to be in any way limiting. Reference is made in detail to implementations of examples as illustrated in the accompanying drawings. The same reference indicators are used throughout the drawings and the description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another. That is, the foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in an embodiment,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a computing apparatus comprising: a computer-readable storage medium; an integration engine comprising processor-executable instructions stored on the computer-readable storage medium; and one or more processors coupled to the computer-readable storage medium and configured to execute the processor-executable instructions, wherein the processor-executable instructions, when executed by the one or more processors, direct the computing apparatus, to at least: receive, via a virtual assistant (VA) application, a first user query from a client device; process the first user query to determine a first transition state, wherein the first transition state indicates a valid query; generate an input for an artificial intelligence (AI) system using the first user query based on the first transition state; responsive to receiving a first output from the AI system, process the first output generated by the AI system to determine a second transition state, wherein the first output comprises a response to the first user query; and generate, by the VA application, an answer to the first user query using the response generated by the AI system.

Example 2 is the computing apparatus of any previous or subsequent Example, wherein: the processor-executable instructions, when executed by the one or more processors, further direct the computing apparatus to: determine, using one or more natural language processing (NLP) techniques, an intent of the first user query; and wherein the processor-executable instructions to generate the input for the AI system using the first user query based on the first transition state, when executed by the one or more processors, further direct the computing apparatus to: generate, via an AI system interface of the integration engine, the input for the AI system, wherein the input comprises the first user query and the intent.

Example 3 is the computing apparatus of any previous or subsequent Example, wherein: the integration engine comprises a state machine; the processor-executable instructions, when executed by the one or more processors, further direct the computing apparatus to: generate a first payload using the first user query, wherein the first payload comprises an intent of the first user query and text of the first user query as submitted to the VA application; and the processor-executable instructions to process the first user query to determine the first transition state, when executed by the one or more processors, further direct the computing apparatus to: process, via the state machine, the first payload to determine whether the intent comprises a valid intent; determine, via the state machine, that the intent of the first payload comprises a valid intent; and determine, via the state machine, the first transition state based on the valid intent.

Example 4 is the computing apparatus of any previous or subsequent Example, wherein: the integration engine comprises an AI system interface; and the processor-executable instructions to generate the input for the AI system using the first user query based on the first transition state, when executed by the one or more processors, further direct the computing apparatus to: determine an intent of the first user query; generate a first payload comprising the intent of the first user query and the first user query; and submit, via the AI system interface, the first payload as the input into the AI system.

Example 5 is the computing apparatus of any previous or subsequent Example, wherein the processor-executable instructions, when executed by the one or more processors, further direct the computing apparatus to: receive, via the VA application, a second user query from the client device; process, via a state machine of the integration engine, the second user query; determine, via the state machine, a second transition state from processing the second user query, wherein the second transition state indicates an invalid query; and generate, by the VA application, a second answer to the second user query based on the second transition state, wherein the second answer indicates that the second user query is an invalid query.

Example 6 is the computing apparatus of any previous or subsequent Example, wherein: the processor-executable instructions, when executed by the one or more processors, further direct the computing apparatus to: generate, responsive to receiving the first output from the AI system, a second input for the AI system requesting summarization of the response in the first output; and receive, responsive to submitting the second input to the AI system, a second output comprising a subsequent response comprising a summary of the response; and the processor-executable instructions to generate, by the VA application, the answer to the first user query using the response generated by the AI system, when executed by the one or more processors, further direct the computing apparatus to: generate, by the VA application, the answer to the first user query using the subsequent response generated by the AI system.

Example 7 is a method comprising: receiving, by an integration engine, a user query from a client device via a virtual assistant (VA) application; determining, by a state machine of the integration engine, a first transition state of a plurality of transition states for the integration engine based on the user query, wherein the first transition state initiates the integration engine to interact with an artificial intelligence (AI) system that is external to the VA application; generating, by the integration engine, an input to the AI system using the user query based on the first transition state; responsive to receiving an output from the AI system, processing the output generated by the AI system to determine a second transition state, wherein the output comprises a response to the user query; and generating, by the VA application, an answer to the user query using the response generated by the AI system.

Example 8 is the method of any previous or subsequent Example, wherein: determining, by the state machine of the integration engine, the first transition state of the plurality of transition states for the integration engine based on the user query further comprises: determining, using natural language processing (NLP), an intent of the user query; and determining, by the state machine of the integration engine, the first transition state for the integration engine based on the intent of the user query; and generating, by the integration engine, the input to the AI system using the user query further comprises: generating, via an AI system interface of the integration engine, the input for the AI system, wherein the input comprises the user query and the intent.

Example 9 is the method of any previous or subsequent Example, wherein the method further comprises: receiving, by the AI system, the input from the integration engine; performing, by the AI system, a semantic search using the input; identifying, by the AI system, one or more knowledge articles that are contextually related to the user query from the semantic search; and generating, by the AI system, the output based on the one or more knowledge articles.

Example 10 is the method of any previous or subsequent Example, wherein responsive to receiving the output from the AI system, processing the output from the AI system to determine the second transition state further comprises: determining, by the integration engine, that the response provided in the output from the AI system requires additional refinement; generating, by the integration engine, a second input to the AI system, wherein the second input comprises a second intent and the user query; and responsive to receiving a second output from the AI system, processing the second output from the AI system to determine the second transition state.

Example 11 is the method of any previous or subsequent Example, wherein generating, by the integration engine, the input to the AI system using the user query based on the first transition state further comprises: determining, by the integration engine, an intent of the user query; determining, by the integration engine, metadata associated with the client device, wherein the metadata comprises at least one of a business object or a user object; and generating, by the integration engine, the input for the AI system, wherein the input comprises the user query, the intent, and the metadata.

Example 12 is the method of any previous or subsequent Example, wherein the AI system comprises a Large Language Model (LLM) trained using a plurality of knowledge articles and corresponding labels comprising intents.

Example 13 is the method of any previous or subsequent Example, wherein the AI system comprises a Large Language Model.

Example 14 is the method of any previous or subsequent Example, wherein: the VA application comprises a legacy VA application; the AI system comprises a Large Language Model (LLM); and the integration engine interfaces between the legacy VA application and the LLM.

Example 15 is a computer-readable storage medium comprising processor-executable instructions, wherein the processor-executable instructions comprise an integration engine configured to cause one or more processors to: receive, from a virtual assistant (VA) application, a user query from a client device; determine, using one or more natural language processes, an intent of the user query; generate a payload using the user query and the intent; and process, by a state machine, the payload to determine whether to process the user query via a plurality of transition states, wherein a first transition state of the plurality of transition states comprises interacting with a large language model (LLM) to generate an answer to the user query.

Example 16 is the computer-readable storage medium of any previous or subsequent Example, wherein: the processor-executable instructions to process, via the state machine, the payload to determine whether to process the user query via the plurality of transition states cause the one or more processors to further execute processor-executable instructions stored in the computer-readable storage medium to: determine, by the state machine, that the user query corresponds to the first transition state from the plurality of transition states; and the processor-executable instructions cause the one or more processors to further execute processor-executable instructions stored in the computer-readable storage medium to: generate, by the integration engine, an input for the LLM using the user query based on the first transition state; responsively receive, by the integration engine, an output from the LLM; and generate, by the VA application, the answer to the user query using the output from the LLM.

Example 17 is the computer-readable storage medium of any previous or subsequent Example, wherein: the processor-executable instructions to process, via the state machine, the payload to determine whether to process the user query via the plurality of transition states cause the one or more processors to further execute processor-executable instructions stored in the computer-readable storage medium to: determine, by the state machine, that the user query corresponds to a second transition state from the plurality of transition states, wherein the second transition state indicates that the intent of the user query is an invalid intent; and the processor-executable instructions cause the one or more processors to further execute processor-executable instructions stored in the computer-readable storage medium to: generate, by the VA application, the answer to the user query indicating the invalid intent of the user query.

Example 18 is the computer-readable storage medium of any previous or subsequent Example, wherein: the processor-executable instructions to process, via the state machine, the payload to determine whether to process the user query via the plurality of transition states cause the one or more processors to further execute processor-executable instructions stored in the computer-readable storage medium to: determine, by the state machine, that the user query corresponds to the first transition state from the plurality of transition states; and the processor-executable instructions cause the one or more processors to further execute processor-executable instructions stored in the computer-readable storage medium to: submit, by the integration engine, an input into the LLM, wherein the input comprises the payload; process, by the integration engine, an output generated by the LLM responsive to submission of the input, wherein the output comprises a response to the user query; and generate, by the integration engine, a second input for the LLM, wherein the second input requests refinement of the response to the user query.

Example 19 is the computer-readable storage medium of any previous or subsequent Example, wherein: the processor-executable instructions to process, via the state machine, the payload to determine whether to process the user query via the plurality of transition states cause the one or more processors to further execute processor-executable instructions stored in the computer-readable storage medium to: determine, by the state machine, that the intent of the user query corresponds to a subset of intents solvable by the VA application; determine, by the state machine, a second transition state for the integration engine based on the intent; and the processor-executable instructions cause the one or more processors to further execute processor-executable instructions stored in the computer-readable storage medium to: generate, by the VA application, the answer to the user query based on the payload and the second transition state.

Example 20 is the computer-readable storage medium of any previous or subsequent Example, wherein the processor-executable instructions to generate the payload using the user query and the intent cause the one or more processors to further execute processor-executable instructions stored in the computer-readable storage medium to: determine metadata associated with the client device, wherein the metadata comprises at least one of a business object or a user object; and generate the payload to comprise the user query, the intent, and the metadata.

What is claimed is:

1. A computing apparatus comprising:
a computer-readable storage medium;
an integration engine comprising processor-executable instructions stored on the computer-readable storage medium; and
one or more processors coupled to the computer-readable storage medium and configured to execute the processor-executable instructions, wherein the processor-executable instructions, when executed by the one or more processors, direct the computing apparatus, to at least:
receive, via a virtual assistant (VA) application, a first user query from a client device;
process the first user query to determine a first transition state, wherein the first transition state indicates a valid query;
generate an input for an artificial intelligence (AI) system using the first user query based on the first transition state;
responsive to receiving a first output from the AI system, process the first output generated by the AI system to determine a second transition state, wherein the first output comprises a response to the first user query; and
generate, by the VA application, an answer to the first user query using the response generated by the AI system.

2. The computing apparatus of claim 1, wherein:
the processor-executable instructions, when executed by the one or more processors, further direct the computing apparatus to:
determine, using one or more natural language processing (NLP) techniques, an intent of the first user query; and
wherein the processor-executable instructions to generate the input for the AI system using the first user query based on the first transition state, when executed by the one or more processors, further direct the computing apparatus to:
generate, via an AI system interface of the integration engine, the input for the AI system, wherein the input comprises the first user query and the intent.

3. The computing apparatus of claim 1, wherein:
the integration engine comprises a state machine;
the processor-executable instructions, when executed by the one or more processors, further direct the computing apparatus to:
generate a first payload using the first user query, wherein the first payload comprises an intent of the first user query and text of the first user query as submitted to the VA application; and
the processor-executable instructions to process the first user query to determine the first transition state, when executed by the one or more processors, further direct the computing apparatus to:
process, via the state machine, the first payload to determine whether the intent comprises a valid intent;
determine, via the state machine, that the intent of the first payload comprises a valid intent; and
determine, via the state machine, the first transition state based on the valid intent.

4. The computing apparatus of claim 1, wherein:
the integration engine comprises an AI system interface; and
the processor-executable instructions to generate the input for the AI system using the first user query based on the first transition state, when executed by the one or more processors, further direct the computing apparatus to:
determine an intent of the first user query;
generate a first payload comprising the intent of the first user query and the first user query; and
submit, via the AI system interface, the first payload as the input into the AI system.

5. The computing apparatus of claim 1, wherein the processor-executable instructions, when executed by the one or more processors, further direct the computing apparatus to:
receive, via the VA application, a second user query from the client device;
process, via a state machine of the integration engine, the second user query;
determine, via the state machine, a second transition state from processing the second user query, wherein the second transition state indicates an invalid query; and
generate, by the VA application, a second answer to the second user query based on the second transition state, wherein the second answer indicates that the second user query is an invalid query.

6. The computing apparatus of claim 1, wherein:
the processor-executable instructions, when executed by the one or more processors, further direct the computing apparatus to:
generate, responsive to receiving the first output from the AI system, a second input for the AI system requesting summarization of the response in the first output; and
receive, responsive to submitting the second input to the AI system, a second output comprising a subsequent response comprising a summary of the response; and
the processor-executable instructions to generate, by the VA application, the answer to the first user query using the response generated by the AI system, when executed by the one or more processors, further direct the computing apparatus to:
generate, by the VA application, the answer to the first user query using the subsequent response generated by the AI system.

7. A method comprising:
receiving, by an integration engine, a user query from a client device via a virtual assistant (VA) application;
determining, by a state machine of the integration engine, a first transition state of a plurality of transition states for the integration engine based on the user query, wherein the first transition state initiates the integration engine to interact with an artificial intelligence (AI) system that is external to the VA application;
generating, by the integration engine, an input to the AI system using the user query based on the first transition state;
responsive to receiving an output from the AI system, processing the output generated by the AI system to determine a second transition state, wherein the output comprises a response to the user query; and
generating, by the VA application, an answer to the user query using the response generated by the AI system.

8. The method of claim 7, wherein:
determining, by the state machine of the integration engine, the first transition state of the plurality of transition states for the integration engine based on the user query further comprises:
determining, using natural language processing (NLP), an intent of the user query; and
determining, by the state machine of the integration engine, the first transition state for the integration engine based on the intent of the user query; and
generating, by the integration engine, the input to the AI system using the user query further comprises:
generating, via an AI system interface of the integration engine, the input for the AI system, wherein the input comprises the user query and the intent.

9. The method of claim 7, wherein the method further comprises:
receiving, by the AI system, the input from the integration engine;
performing, by the AI system, a semantic search using the input;
identifying, by the AI system, one or more knowledge articles that are contextually related to the user query from the semantic search; and
generating, by the AI system, the output based on the one or more knowledge articles.

10. The method of claim 7, wherein responsive to receiving the output from the AI system, processing the output from the AI system to determine the second transition state further comprises:
determining, by the integration engine, that the response provided in the output from the AI system requires additional refinement;
generating, by the integration engine, a second input to the AI system, wherein the second input comprises a second intent and the user query; and
responsive to receiving a second output from the AI system, processing the second output from the AI system to determine the second transition state.

11. The method of claim 7, wherein generating, by the integration engine, the input to the AI system using the user query based on the first transition state further comprises:
determining, by the integration engine, an intent of the user query;
determining, by the integration engine, metadata associated with the client device, wherein the metadata comprises at least one of a business object or a user object; and
generating, by the integration engine, the input for the AI system, wherein the input comprises the user query, the intent, and the metadata.

12. The method of claim 7, wherein the AI system comprises a Large Language Model (LLM) trained using a plurality of knowledge articles and corresponding labels comprising intents.

13. The method of claim 7, wherein the AI system comprises a Large Language Model.

14. The method of claim 7, wherein:
the VA application comprises a legacy VA application;
the AI system comprises a Large Language Model (LLM); and
the integration engine interfaces between the legacy VA application and the LLM.

15. A computer-readable storage medium comprising processor-executable instructions, wherein the processor-executable instructions comprise an integration engine configured to cause one or more processors to:
receive, from a virtual assistant (VA) application, a user query from a client device;
determine, using one or more natural language processes, an intent of the user query;
generate a payload using the user query and the intent; and
process, by a state machine, the payload to determine whether to process the user query via a plurality of transition states, wherein a first transition state of the plurality of transition states comprises interacting with a large language model (LLM) to generate an answer to the user query.

16. The computer-readable storage medium of claim 15, wherein:
the processor-executable instructions to process, via the state machine, the payload to determine whether to process the user query via the plurality of transition states cause the one or more processors to further execute processor-executable instructions stored in the computer-readable storage medium to:
determine, by the state machine, that the user query corresponds to the first transition state from the plurality of transition states; and
the processor-executable instructions cause the one or more processors to further execute processor-executable instructions stored in the computer-readable storage medium to:
generate, by the integration engine, an input for the LLM using the user query based on the first transition state;
responsively receive, by the integration engine, an output from the LLM; and
generate, by the VA application, the answer to the user query using the output from the LLM.

17. The computer-readable storage medium of claim 15, wherein:
the processor-executable instructions to process, via the state machine, the payload to determine whether to process the user query via the plurality of transition states cause the one or more processors to further execute processor-executable instructions stored in the computer-readable storage medium to:
determine, by the state machine, that the user query corresponds to a second transition state from the plurality of transition states, wherein the second transition state indicates that the intent of the user query is an invalid intent; and
the processor-executable instructions cause the one or more processors to further execute processor-executable instructions stored in the computer-readable storage medium to:
generate, by the VA application, the answer to the user query indicating the invalid intent of the user query.

18. The computer-readable storage medium of claim 15, wherein:
the processor-executable instructions to process, via the state machine, the payload to determine whether to process the user query via the plurality of transition states cause the one or more processors to further execute processor-executable instructions stored in the computer-readable storage medium to:
determine, by the state machine, that the user query corresponds to the first transition state from the plurality of transition states; and
the processor-executable instructions cause the one or more processors to further execute processor-executable instructions stored in the computer-readable storage medium to:
submit, by the integration engine, an input into the LLM, wherein the input comprises the payload;
process, by the integration engine, an output generated by the LLM responsive to submission of the input, wherein the output comprises a response to the user query; and
generate, by the integration engine, a second input for the LLM, wherein the second input requests refinement of the response to the user query.

19. The computer-readable storage medium of claim 15, wherein:
the processor-executable instructions to process, via the state machine, the payload to determine whether to process the user query via the plurality of transition states cause the one or more processors to further execute processor-executable instructions stored in the computer-readable storage medium to:
determine, by the state machine, that the intent of the user query corresponds to a subset of intents solvable by the VA application;
determine, by the state machine, a second transition state for the integration engine based on the intent; and
the processor-executable instructions cause the one or more processors to further execute processor-executable instructions stored in the computer-readable storage medium to:
generate, by the VA application, the answer to the user query based on the payload and the second transition state.

20. The computer-readable storage medium of claim 15, wherein the processor-executable instructions to generate the payload using the user query and the intent cause the one or more processors to further execute processor-executable instructions stored in the computer-readable storage medium to:
determine metadata associated with the client device, wherein the metadata comprises at least one of a business object or a user object; and
generate the payload to comprise the user query, the intent, and the metadata.
